(19) United States
(12) Patent Application Publication
(10) Pub. No.: US 2025/0121627 A1
(43) Pub. Date: Apr. 17, 2025

(54) COLLECTIBLE ITEM AND METHOD OF MANUFACTURING THE COLLECTIBLE ITEM

(71) Applicant: The Topps Company, Inc., New York, NY (US)

(72) Inventor: Brandon M. Lesley, New York, NY (US)

(73) Assignee: The Topps Company, Inc., New York, NY (US)

(21) Appl. No.: 18/916,339

(22) Filed: Oct. 15, 2024

Related U.S. Application Data
(60) Provisional application No. 63/590,669, filed on Oct. 16, 2023.

(51) Int. Cl. B44C 5/00; B42D 15/00; B44C 1/24

(52) U.S. Cl. CPC B44C 5/00; B42D 15/00; B44C 1/24

(57) ABSTRACT

A collectible item can include a front sheet comprising one or more signatures, a back sheet, and a UV coating applied over the front sheet. A method of manufacturing the collectible item can include applying, via a first printing pass, a target on the front sheet. The target can indicate a location for application of a signature to the front sheet. The front sheet may then be received with the signature in the location indicated by the target. The method can also include applying, via a second printing pass, one or more images, text, or a combination thereof on the front sheet in at least one location. The at least one location can exclude the location indicated by the target. The back sheet can be adhered to the front sheet, and a size of the front sheet and the back sheet can be reduced to generate the collectible item.

### CROSS-REFERENCES TO RELATED APPLICATIONS

This application claims the benefit of U.S. Provisional Application No. 63/590,669, filed on Oct. 16, 2023, and entitled “Collectible Item And Method Of Manufacturing The Collectible Item”, the entirety of which is hereby incorporated by reference herein.

### TECHNICAL FIELD

The present disclosure relates generally to collectible items and, more particularly (although not necessarily exclusively), to a collectible item comprising a front sheet, a back sheet, and a UV coating, and a method of manufacturing the collectible item.

### BACKGROUND

Collectible items can include trading cards, pictures, or other memorabilia. The trading cards, for example, can be small cards, which typically contain an image of a person, place, or thing. The person, place, or thing can be fictional or non-fictional. The trading cards may further contain a short description of the image or additional text (e.g., statistics or trivia) related to the person, place, or thing. A particular example of a trading card is a relic card, which can contain a physical object (e.g., a piece of an athlete's jersey worn during a championship game), a picture, or another suitable object representative of a person, place, or thing.

The collectible items, whether trading cards, relic cards, pictures, or other memorabilia, are often more highly prized and valued when they are signed by a person depicted on or related to the collectible item. For example, a Michael Jordan trading card signed by Michael Jordan can have more value than an unsigned Michael Jordan trading card. However, while it is desirable to have signatures on the collectible items, the collection of signatures can be difficult, and the collectible items can be damaged during the collection and application of the signatures. Additionally, for a signature applied directly on top of a collectible, ink used to apply the signature may be damaged over time. Thus, there can be a need for a collectible item on which signatures can be safely applied and preserved.

### SUMMARY

Aspects of the present relate to a collectible item and a method of manufacturing a collectible item. One aspect relates to a method of manufacturing a collectible item. The method includes applying, via a first printing pass, a target on a front sheet of the collectible item, the target indicating a location for application of a signature to the front sheet, receiving the front sheet with the signature in the location indicated by the target, applying, via a second printing pass, one or more images, text, or a combination thereof on the front sheet in at least one location, adhering the front sheet to a back sheet, and subsequent to adhering the front sheet to the back sheet, reducing a size of the front sheet and the back sheet to generate the collectible item.

In some embodiments, the at least one location excludes the location indicated by the target. In some embodiments, the method can further include applying, via a third printing pass, one or more embellishments to the front sheet. In some embodiments, the one or more embellishments are selected from a group including at least one of foil, stickers, or holographic stickers. In some embodiments, applying, via the third printing pass, the one or more embellishments to the front sheet can include applying the one or more embellishments via foil stamping.

In some embodiments, the method can further include applying, via a fourth printing pass, a UV coating over the signature and over the one or more images, the text, or the combination thereof on the front sheet. In some embodiments, the UV coating can be a UV curable writable clear.

In some embodiments, the method can further include, subsequent to applying the UV coating via the fourth printing pass, curing the UV coating by passing the front sheet with the UV coating under one or more UV lamps. In some embodiments, a temperature of the front sheet is below a temperature threshold during the application of the UV coating.

In some embodiments, the method can further include, subsequent to receiving the front sheet with the signature in the location indicated by the target, generating the one or more images, the text, or the combination thereof for application during the second printing pass. In some embodiments, a first thickness of the front sheet is equivalent to a second thickness of the back sheet. In some embodiments, a first thickness of the front sheet is less than a second thickness of the back sheet. In some embodiments, a material of the front sheet is selected from a group including at least one of cardstock, paper stock, or plastic. In some embodiments, the collectible item is a relic card. In some embodiments, the first printing pass and the second printing pass involve digital printing. In some embodiments, at least one of the first printing pass and the second printing pass can include digital printing.

One aspect of the present disclosure relates to a collectible item. The collectible item can include a front sheet including a signature on a top surface of the front sheet and including one or more images, text, or a combination thereof on the top surface, a back sheet, and a UV coating applied over the top surface of the front sheet such that the signature and the one or more images, text, or the combination thereof are underneath the UV coating.

In some embodiments, a material of at least one of the front sheet and the back sheet can be cardstock. In some embodiments, a material of at least one of the front sheet and the back sheet can be paper. In some embodiments, a material of at least one of the front sheet and the back sheet can be photopaper. In some embodiments, the collectible item can include a target indicating a location for the signature. In some embodiments, at least a portion of the signature overlays at least a portion of the target. In some embodiments, the collectible item can further include a spacer layer containing a relic.

### BRIEF DESCRIPTION OF THE DRAWINGS

FIG. 1 illustrates an example of a collectible item, according to an embodiment of the present disclosure.

FIG. 2 illustrates an example of the collectible item after a first printing pass, according to an embodiment of the present disclosure.

FIG. 3 illustrates an example of the collectible item after a second printing pass, according to an embodiment of the present disclosure.

FIG. 4 illustrates embellishments for application to the collectible item via a third printing pass, according to an embodiment of the present disclosure.

FIG. 5A illustrates an example of a sheet used for generating collectible items, according to an embodiment of the present disclosure.

FIG. 5B illustrates a cross-sectional view of the sheet along plane A-A, as shown in FIG. 5A, according to an embodiment of the present disclosure.

FIG. 6 is a flow chart of an example of process for generating a collectible item, according to an embodiment of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure relate to collectible items and, more specifically, to the manufacturing of collectible items including one or more signatures. The collectible items may each include a front sheet on which the one or more signatures can be applied within locations indicated by one or more targets. Additionally, the collectible items can each include a UV coating applied over a top surface of the front sheet and a back sheet adhered to a back surface of the front sheet.

A method described herein can include, applying, via a first printing pass, one or more targets on a front sheet (e.g., paper, cardstock, etc.). After the first printing pass, the front sheet may be transmitted to an individual. The individual can sign the front sheet in locations indicated by the one or more targets. The front sheet may then be received with the signatures and the method can further include performing a second printing pass. The first and second printing passes can involve digital printing. In particular, the second printing pass can involve applying images, text, or a combination thereof to the front sheet in one or more locations. The one or more locations may exclude the locations indicated by the targets. The images, text, or the combination thereof may be associated with the individual that signed the collectible item. The method can also include adhering the front sheet to a back sheet using, for example, a water-based glue. Additionally, the method can include reducing a size of the adhered front and back sheets to generate the collectible item or to generate multiple collectible items.

In some examples, prior to adhering the front and back sheets, the method may include performing a third printing pass to apply embellishments, such as foil, stickers, or numbering, to the front sheet. Additionally, in some examples, the method can include performing a fourth printing pass to apply a UV coating to the front sheet over the signatures, images, text, and embellishments. The UV coating can include, for example, a UV curable writeable clear. The fourth printing pass may further include passing the front sheet, with the applied UV coating, under one or several UV lamps, to cure the UV coating.

The collectible item may therefore be created via a multi-layered printing and manufacturing process. In this process, one or more signatures may be applied to a layer (e.g., the front sheet) of the collectible item before the manufacturing of the collectible item is complete. For example, the signatures can be applied before images, embellishments, etc. are applied to the collectible item, before a UV coating is applied to the collectible item, and before different layers (e.g., the front sheet and the back sheet) of the collectible item are assembled. By applying the signatures before the collectible item is complete, a likelihood of damage to the collectible item can be reduced. For example, the collectible item, as a whole, cannot be bent, lost, or otherwise damaged during retrieval of the signatures. Moreover, the images, embellishments, or other suitable features of the collectible item that have not yet been applied cannot be disturbed. Thus, by sending the front sheet to be signed rather than a finalized version of a valuable collectible item, the collectible item can be protected from damage that may occur during transport or signing.

Additionally, by providing an individual with the front sheet to collect signatures, a process of collecting the signatures can be simplified. For example, a current process may involve sending separate collectible items to the individual to sign. In contrast, the front sheet can be used to collect multiple signatures and to manufacture multiple collectible items. Thus, rather than signing multiple, separate items, the individual can sign one sheet multiple times to improve efficiency and simplify the process of collecting signatures.

Moreover, by applying the signatures prior to completion of the collectible items, the signatures can be protected and preserved. For example, printing passes occurring subsequent to the application of the signatures can be updated to prevent the images, text, or embellishments from covering, distorting, or otherwise negatively affecting the signatures. Additionally, a UV coating can be applied over the signatures to provide a protective barrier and preserve the signatures.

While the markings applied to the front sheet are illustrated and described herein as signatures, the markings are not limited as such and can apply to other types of marks, such as text or drawings.

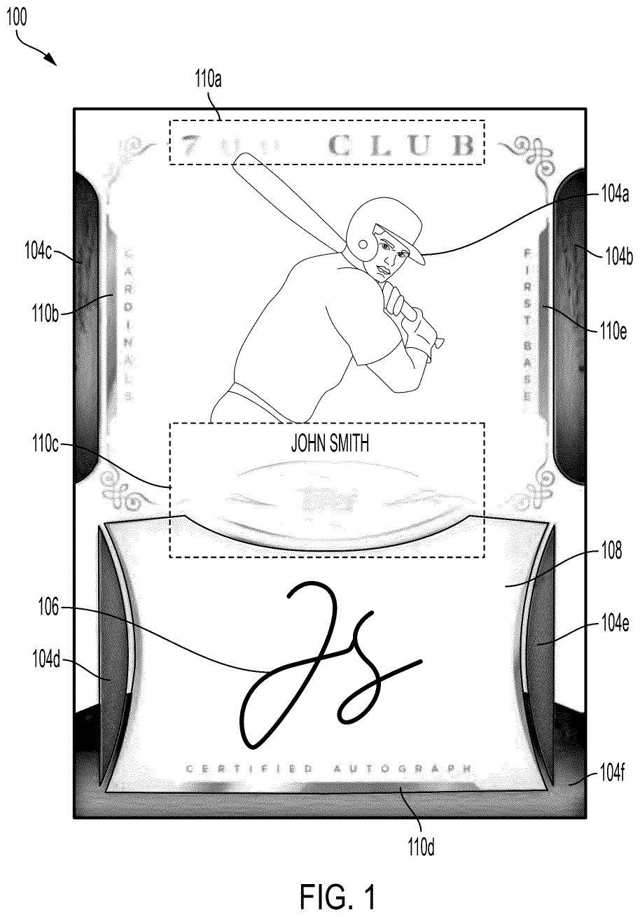

Referring now to the drawings, FIG. 1 illustrates an example of a collectible item 100, according to an embodiment of the present disclosure. As depicted, the collectible item 100 can be a trading card. In other examples, the collectible item 100 can be a relic card, a photo, or other suitable memorabilia. The collectible item 100 can include a front sheet, a back sheet, and a UV coating. In an example in which the collectible item 100 is a relic card, the collectible item 100 can further include a spacer layer between the front sheet and the back sheet, in which a relic (e.g., an image or a piece of an athlete's jersey) can be positioned. Additionally, in the example in which the collectible item 100 is the relic card, the front sheet can comprise a window to enable viewing of the relic.

The collectible item 100 can further include a target 108, which can provide a location for application of a signature 106 on to the collectible item 100. Thus, as depicted, the signature 106 can overlay the target 108. Additionally, the collectible item 100 can include text, one or more images 104a-f, or a combination thereof. For example, a first image 104a may depict an athlete associated with the collectible item 100. The text may therefore include a description of the athlete, statistics, trivia, or other suitable information related to the athlete, the athlete's team, or the like. Additional images 104b-f, can be any suitable image of any suitable shape, color, etc. For example, the additional images 104b-f may also be representative of a person, place, or thing (e.g., the athlete, sport, team, etc.) associated with the collectible item 100 or the additional images 104b-f can be for design. The collectible item 100 can also include embellishments 110a-e for providing additional information related to the collectible item 100 or for enhancing the design of the collectible item 100. The embellishments 110a-e may include foil, stickers, holographic stickers, or the like. Additionally, the embellishments 110a-e can include text (e.g., lettering or numbering), which may be made of foil or another suitable material.

The target 108, the signature 106, the images 104a-f, the text, the embellishments 110a-e, or a combination thereof may be applied to a top surface of the front sheet of the collectible item 100. The UV coating may then be applied over the top surface of the front sheet. Thus, the

UV coating can overlay the target 108, the signature 106, the images 104a-f, the text, the embellishments 104a-d, or the combination thereof. The UV coating can be a thin, clear layer of UV curable writable clear or another suitable UV curable material. The UV coating can increase a durability of the collectible item 100 and can protect the target 108, the signature 106, the images 102, the text, the embellishments 104a-c, or the combination thereof.

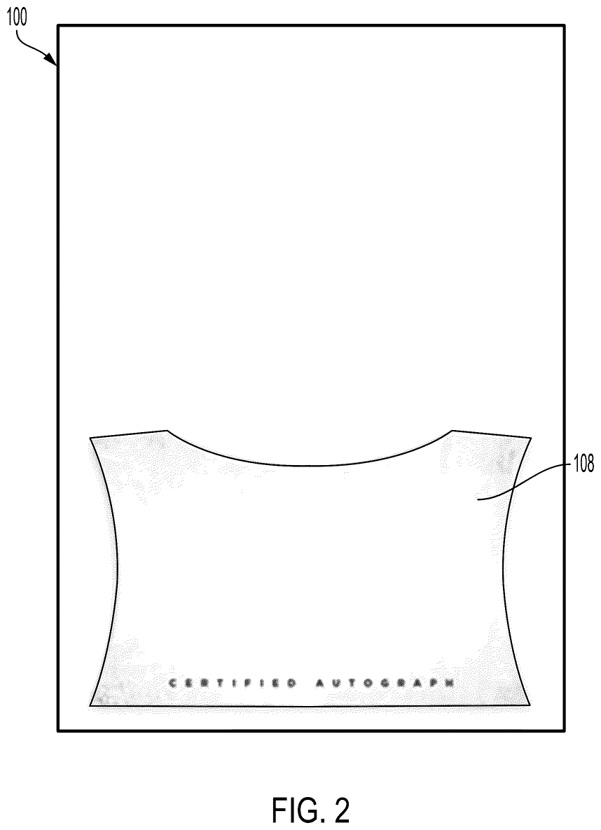

FIG. 2 illustrates the collectible item 100 after a first printing pass, according to an embodiment of the present disclosure. The first printing pass can be performed on a front sheet from which one or more collectible items, including the collectible item 100, may be generated. The first printing pass can include applying one or more targets onto the front sheet in locations associated with the one or more collectible items that will be generated. The one or more targets applied via the first printing pass can be one color, four colors, or any desired number of colors. Thus, after the first printing pass, the collectible item 100 can include target 108. The target 108 can indicate a location for placement of a signature on the collectible item 100. After the first pass of printing is performed, the front sheet, with the target 108 applied to collectible item 100, can be provided to an individual for signing.

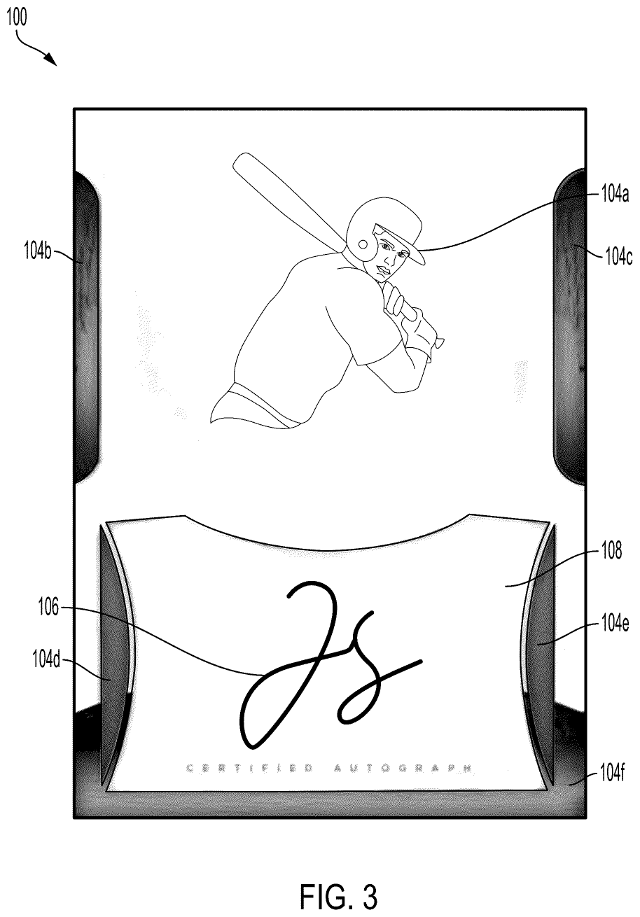

FIG. 3 illustrates the collectible item 100 after a second printing pass, according to an embodiment of the present disclosure. The second printing pass may be performed on the front sheet subsequent to the first printing pass and after the signature 106 has been applied in the location indicated by the target 108. As a result of the second printing pass, the collectible item 100 can include images 104a-f. In some examples, the collectible item 100 may also include text (e.g., a description of the collectible item, statistics, etc.) after the second printing pass. As shown, a first image 104a on the collectible item can be of an individual (e.g., an athlete). The individual in the first image 104a can correspond to the individual from which the signature 106 was received. The second printing pass can include one color printing or multicolor printing. For example, the second printing pass can include four color printing, in which the four colors may be cyan, magenta, yellow, and black.

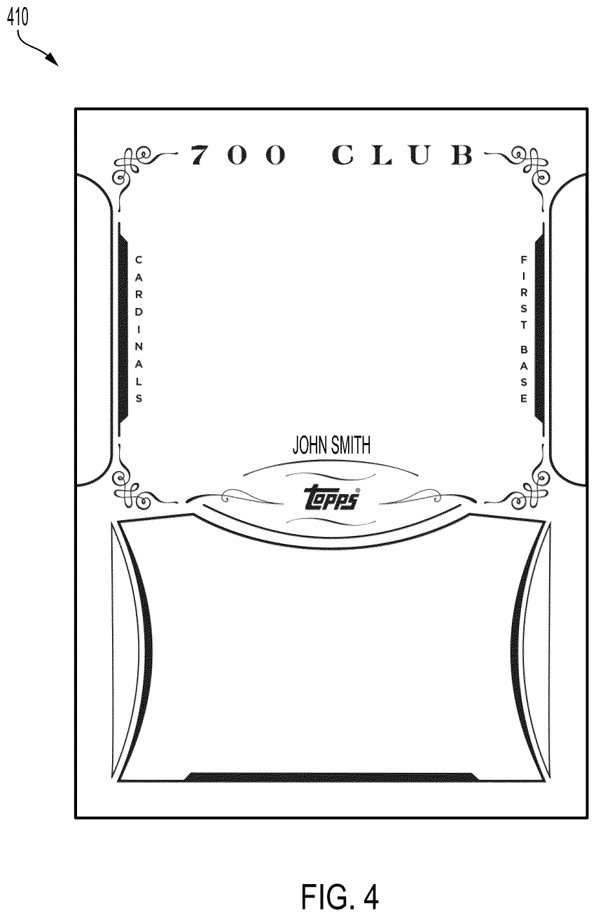

FIG. 4 illustrates embellishments 410 for application to the collectible item 100 via a third printing pass, according to an embodiment of the present disclosure. The embellishments 410 can correspond to the embellishments 104a-e applied to the collectible item 100, as depicted in FIG. 1. The third printing pass used to apply the embellishments 410 can be performed subsequent to the first and second printing passes. The embellishments 410 can be stickers, foil, or other suitable types of embellishments. In some examples, the stickers, foil, or the like of the embellishments 410 can be in the form of numbers or letters. As depicted, the embellishments 410 consisting of numbers, letters, or a combination thereof may provide a name of the individual represented by the collectible item 100, a team associated with the individual, a positioning of the individual in their respective sport (e.g., baseball), or other suitable information. The embellishments can also include shapes made of foil, stickers, etc., which can be applied around the images 104a-f, signature 106, target 108, or other suitable features of the collectible item 100.

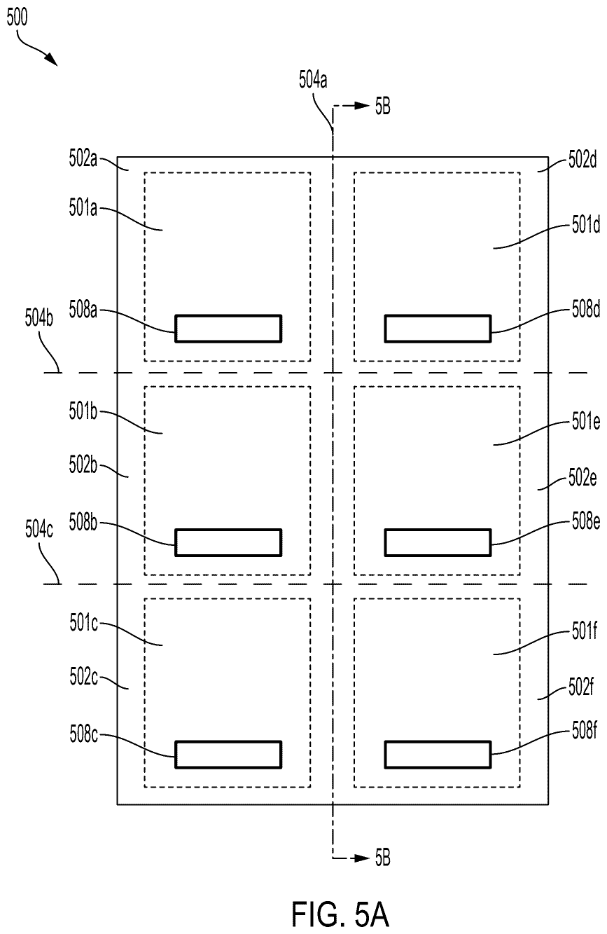

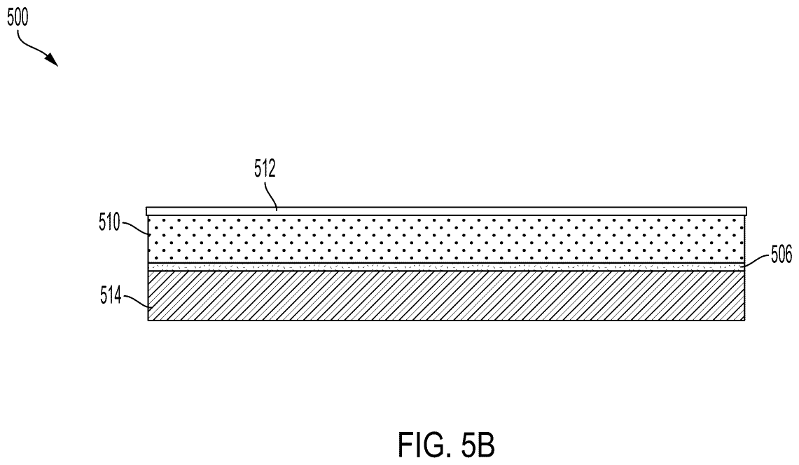

FIG. 5A illustrates an example of a sheet 500 used for generating collectible items 501a-f, according to an embodiment of the present disclosure. The sheet 500 can include outlines or other suitable indications of each of the collectible items 501a-f. A first collectible item 501a can correspond to collectible item 100 depicted in FIGS. 1-3. The sheet 500 can also include targets 508a-f within each of the collectible items 501a-f. Each of the targets 508a-f can indicate a location for an individual to sign the sheet 500. Thus, the sheet 500 may be provided to one or more individuals for the application of the signatures in the locations indicated by the targets 508a-f. For example, the sheet 500 can be provide to a famous baseball player. The famous baseball player may sign the sheet 500 multiple times such that their signature 106 appears inside each of the targets 508a-f.

The sheet 500 can be dimensioned such that the collectible items 501a-f can be separated by a distance to enable the sheet to be cut and trimmed into the collectible items 501a-f. For example, to generate each of the collectible items 501a-f, the sheet 500 may be cut along the dashed lines 504a-c. As a result, the sheet 500 may be separated into six similarly sized sheet pieces 502a-f. The sheet pieces 502a-f may then be trimmed or otherwise altered to generate the six separate collectible items 501a-f.

By using the sheet 500 to obtain multiple signatures and generate multiple collectible items, the signatures can be collected in an efficient and safe manner. That is, instead of providing the one or more individuals with multiple collectible items to sign, which can be difficult to handle and easily lost or damaged, the sheet 500 can be provided for the individual to apply their signature 106 multiple times. Additionally, the sheet 500 can be provided to the individual prior to completion of the collectible items 501a-f. For example, prior to applying images, text, embellishments, or a UV coating to the collectible items 501a-f. In this way, the images, text, etc. cannot be damaged during application or retrieval of the signatures. Moreover, by applying the signatures within the locations indicated by the targets 508a-f and before the application of the images, text, etc., the signatures can be easier to read than a signature applied to a collectible item over or near pre-applied images.

FIG. 5B illustrates a cross-sectional view of the sheet 500 along plane A-A, as shown in FIG. 5A, according to an embodiment of the present disclosure. As depicted, the sheet 500 can include a front sheet 510 and a back sheet 514. The front sheet 510, the back sheet 514, or a combination thereof can comprise a single sheet of material or can be made from a combination of multiple sheets of material. For example, each of the front sheet 510 and the back sheet 514 can be created from one or more uncoated materials such as an uncoated cardstock, cardboard, paper, paper stock, photopaper, plastic, or other suitable material.

In some examples, a first thickness of the front sheet 510 and a second thickness of the back sheet 514 can be different. For example, the second thickness of the back sheet 514 may be greater than the first thickness of the front sheet 510. In other examples, the first thickness and the second thickness can be equal. In a particular example, the first thickness of the front sheet 510 can be between 0.006 inches and 0.018 inches. Similarly, a second thickness of the back sheet may be between, 0.006 inches thick and 0.018 inches thick. A combined thickness of the front sheet 510 and the back sheet 514 can be between 0.012 inches and 0.036 inches.

Additionally, the front sheet 510 and the back sheet 514 can have any suitable dimensions. For example, dimensions of the front sheet 510, the back sheet 514, or a combination thereof may be approximately 28 inches by approximately 40 inches. In another example, dimensions of the front sheet 510, the back sheet 514, or a combination thereof may be approximately 16 inches by approximately 20 inches. Each of the front sheet 510 and the back sheet 514 can be sized such that multiple collectible items can be created from the combination of the front sheet 510 and the back sheet 514. For example, the front sheet 510 and the back sheet 514 can be large to create the six collectible items 501a-f depicted in FIG. 5A.

Furthermore, an adhesive 506 can be applied on a bottom surface of the front sheet 510 and on a top surface of the back sheet 514. Then, the bottom surface of the front sheet 510 and the top surface of the back sheet 514 can be pressed together to generate the sheet 500. The adhesive 506 may comprise a water-based glue or another suitable adhesive material. Alternatively, in an example in which the collectible item 100 is a relic card, the sheet 500 may further include a spacer layer. The spacer layer can provide a space for holding a relic. Thus, in the example, the adhesive 506 may be applied on a top and bottom surface of the spacer layer. Then, the front sheet 510 can be adhered to the top surface of the spacer layer and the back sheet 514 can be adhered to the bottom surface of the space layer.

A UV coating 512 can be an additional layer applied to a top surface of the front sheet 510. The UV coating 512 can include a UV curable writable clear or other suitable type of UV curable material. The UV coating 512 can be clear to enable signatures, images, or other suitable features applied to the front sheet 510 to be visible after application of the UV coating 512. The UV coating 512 can further act as a protective layer over the signatures, images, or other suitable features of the front sheet 510.

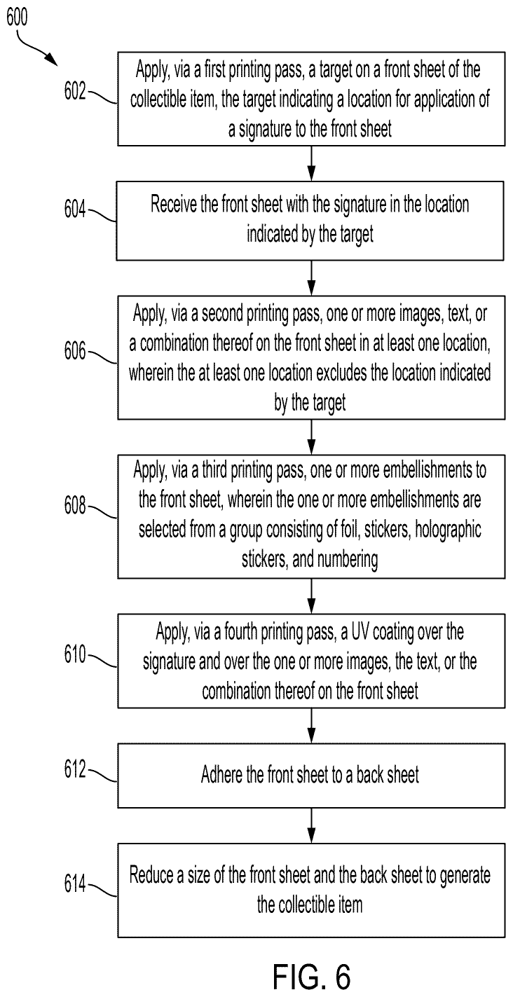

FIG. 6 is a flow chart of an example of a process 600 for generating a collectible item 100, according to an embodiment of the present disclosure. While FIG. 6 depicts a certain sequence of steps for illustrative purposes, other examples can involve more steps, fewer steps, different steps, or a different order of the steps than is depicted in FIG. 6. The steps of FIG. 6 are described below with reference to the components of FIGS. 1-5B described above.

At block 602, the process 600 can involve applying, via a first printing pass, a target 108 on a front sheet 510 of the collectible item 100, the target 108 indicating a location for application of a signature 106 to the front sheet 510. Prior to the first printing pass, the front sheet 510 can be selected based a desired size, thickness, and material. In an example, the size of the front sheet 510 can be 28 inches by 40 inches, the thickness can be 0.012 inches, and the material can be cardstock, paper stock, or plastic. Once the front sheet 510 is selected, the first printing pass can be performed on the front sheet 510. In the example, a first collectible item 501a of sheet 500 can correspond to the collectible item 100 depicted in FIG. 1. Thus, by performing the first printing pass on the front sheet 510, a first target 508a can be applied to the first collectible item 501a. Additionally, via the first printing pass, targets 508b-f may be applied to the remaining collectible items 501b-f of the front sheet 510. The first printing pass can be in one color or can be in any desired number of colors.

At block 604, the process 600 can involve receiving the front sheet 510 with the signature 106 in the location indicated by the target 108. In the example, after the targets 508a-f are applied to the front sheet 510, the front sheet 510 can be sent to an individual for signing. The individual may sign the front sheet 510 in the locations indicated by the targets 508a-f and can return the front sheet 510. Thus, the front sheet 510 can be returned with the signature 106 in the location indicated by the first target 508a.

At block 606, the process 600 can involve applying, via a second printing pass, one or more images 104a-f, text, or a combination thereof on the front sheet 510 in at least one location. The images 104a-f can include a photo of the individual that signed the collectible item 100 or other suitable images. The text may include a description of the individual or other suitable information. The second printing pass can also include printing the images 104a-f, text, or the combination thereof onto the collectible items 501b-f of the front sheet 510. The second printing pass can include one color printing, or multicolor printing. In the example, the second printing pass can include four color printing, in which the four colors can include cyan, magenta, yellow, and black.

Additionally, the at least one location of the images 104a-f, text, or the combination thereof can exclude the location indicated by the first target 508a. In this way, the application of the images 104a-f, text, or the combination thereof may not overlap with or damage the signature 106. Moreover, in some examples, the front sheet 510 can be maintained at or below a threshold temperature during the second printing pass to prevent damage to the signature 106. Thus, the threshold temperature can be a temperature at or below which ink of the signature cannot be distorted or otherwise damaged as a result of the second printing pass. The front sheet 510 can be maintained at or below the threshold temperature for the remaining steps of the process 600.

In some examples, the images 104a-f, text, or the combination thereof applied in the second printing pass can be generated after the receipt of the signed front sheet. In this way, the images, text, or the combination thereof can be generated to best fit the collectible item 100 with the target 108 and signature 106. For example, a portion of the signature 106 may be outside of the location indicated by the target 108. Therefore, the images, text, or combination thereof generated after receipt of the signed front sheet 510 can be generated such that the portion of the signature 106 outside of the target 108 is not damaged or covered.

At block 608, the process 600 can involve applying, via a third printing pass, one or more embellishments 110a-e to the front sheet 510. The one or more embellishments 110a-e can be selected from a group consisting of foil, stickers, and holographic stickers. The third printing pass can include creating the embellishments 110a-e and applying the embellishments to the card 110a-f. The application of the embellishments 110a-e can include foil stamping or another suitable application process.

At block 610, the process 600 can involve applying, via a fourth printing pass, a UV coating 612 over the signature 106 and over the one or more images 104a-f, text, or the combination thereof on the front sheet 510. The fourth printing pass can include applying the UV coating 512 via a roller or via a blanket coater. The UV coating 523 can include a UV curable writeable clear or other suitable type of UV coating. After application of the UV coating 512, the fourth printing pass can include curing the UV coating 512 by passing the front sheet 510 under one or more UV lamps, each of which can include one or more UVLEDs.

At block 412, the process 600 can involve adhering the front sheet 510 to a back sheet 514. The adhering of the front sheet 510 to the back sheet 514 can include applying an adhesive 506 to one or both of a back surface of the front sheet 510 and a top surface of the back sheet 514. The adhesive 506 may be a water-based glue. The front sheet 510 and the back sheet 514 may then be pressed together to create a single sheet (e.g., sheet 500) from which collectible items 501a-f can be generated.

At block 414, the process 600 can involve reducing a size of the front sheet 510 and the back sheet 514 to generate the collectible item 100. To reduce the size of the front sheet 510 and the back sheet 514, the combined sheet 500 created at block 412 can be cut along dashed lines 506a-c into sheets pieces 502a-f. The sheet pieces 502a-f may be trimmed to create collectible items 501a-f in a final size. In particular, a first sheet piece 502a can be trimmed to generate the first collectible item 501a which can correspond to the collectible item 100. In other examples, final size collectible items can be cut from the sheet 500 in a single step. The final size of the collectible items 501a-f can be, for example, 2.5 inches by 3.5 inches, 5 inches by 7 inches, 8 inches by 10 inches, or any other suitable size. In some examples, after the first collectible item 501a is generated, the first collectable item 501a can be packaged, framed, sealed in a case, integrated into a plaque, or the like.

The specification and drawings are to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method of manufacturing a collectible item, the method comprising:
applying, via a first printing pass, a target on a front sheet of the collectible item, the target indicating a location for application of a signature to the front sheet;
receiving the front sheet with the signature in the location indicated by the target;
applying, via a second printing pass, one or more images, text, or a combination thereof on the front sheet in at least one location, wherein the at least one location excludes the location indicated by the target;
adhering the front sheet to a back sheet; and
subsequent to adhering the front sheet to the back sheet, reducing a size of the front sheet and the back sheet to generate the collectible item.

2. The method of claim 1, further comprising applying, via a third printing pass, one or more embellishments to the front sheet, wherein the one or more embellishments are selected from a group consisting of foil, stickers, and holographic stickers.

3. The method of claim 2, wherein applying, via the third printing pass, the one or more embellishments to the front sheet comprises applying the one or more embellishments via foil stamping.

4. The method of claim 1, further comprising applying, via a fourth printing pass, a UV coating over the signature and over the one or more images, the text, or the combination thereof on the front sheet.

5. The method of claim 4, wherein the UV coating comprises a UV curable writable clear.

6. The method of claim 4, further comprising, subsequent to applying the UV coating via the fourth printing pass, curing the UV coating by passing the front sheet with the UV coating under one or more UV lamps.

7. The method of claim 4, wherein a temperature of the front sheet is below a temperature threshold during the application of the UV coating.

8. The method of claim 1, further comprising, subsequent to receiving the front sheet with the signature in the location indicated by the target, generating the one or more images, the text, or the combination thereof for application during the second printing pass.

9. The method of claim 1, wherein a first thickness of the front sheet is equivalent to a second thickness of the back sheet.

10. The method of claim 1, wherein a first thickness of the front sheet is less than a second thickness of the back sheet.

11. The method of claim 1, wherein a material of the front sheet is selected from a group consisting of cardstock, paper stock, and plastic.

12. The method of claim 1, wherein the collectible item is a relic card.

13. The method of claim 1, wherein the first printing pass and the second printing pass involve digital printing.

14. A collectible item comprising:
a front sheet comprising a signature on a top surface of the front sheet and comprising one or more images, text, or a combination thereof on the top surface;
a back sheet; and
a UV coating applied over the top surface of the front sheet such that the signature and the one or more images, text, or the combination thereof are underneath the UV coating.

15. The collectible item of claim 14, wherein a material of at least one of the front sheet and the back sheet comprises cardstock.

16. The collectible item of claim 14, wherein a material of at least one of the front sheet and the back sheet comprises paper.

17. The collectible item of claim 14, wherein a material of at least one of the front sheet and the back sheet comprises photopaper.

18. The collectible item of claim 14, further comprising a target indicating a location for the signature.)

19. The collectible item of claim 18, wherein at least a portion of the signature overlays at least a portion of the target.

20. The collectible item of claim 14, further comprising a spacer layer containing a relic.
